(19) United States
(12) Patent Application Publication
(10) Pub. No.: US 2017/0004594 A1
(43) Pub. Date: Jan. 5, 2017

(54) CLINICAL DATA EXCHANGE FOR SUPPORTING TRANSACTIONS IN CLINICAL RESEARCH DATA

(71) Applicants: Richard E. Gliklich, Weston, MA (US); Daniel Zvilevy, Waban, MA (US); David Richard Schatten, Cambridge, MA (US)

(72) Inventors: Richard E. Gliklich, Weston, MA (US); Daniel Zvilevy, Waban, MA (US); David Richard Schatten, Cambridge, MA (US)

(21) Appl. No.: 12/500,105

(22) Filed: Jul. 9, 2009

Related U.S. Application Data
(60) Provisional application No. 61/079,285, filed on Jul. 9, 2008.

(51) Int. Cl. H04L 12/28; G06Q 50/00; G06F 17/30

(52) U.S. Cl. CPC G06Q 50/24

(57) ABSTRACT

A clinical data exchange includes multiple independent databases, each storing clinical data for patients and made available by participants in the exchange. Each database is a node in the clinical data exchange. The exchange enables participants to offer clinical data for research and enables researchers to engage in transactions regarding clinical data from multiple participants. The clinical data exchange includes an interface through which a researcher defines characteristics of data. A query identifies participant nodes that may store such data. The researcher selects one or more of the participant nodes with which the researcher would like to engage in the transaction regarding the clinical data of the selected participant. An application notifies the selected participant nodes that a transaction has been requested, and collects responses from the participant nodes indicating whether the participants accepted the transaction.

### CROSS REFERENCE TO RELATED APPLICATIONS

This application is a nonprovisional application that claims priority to, and the benefits under 35 U.S.C. §119 of, U.S. provisional patent application Ser. No. 61/079,285, filed Jul. 9, 2008, which is hereby incorporated by reference.

### SUMMARY

A clinical data exchange includes multiple independent databases, each storing clinical data for patients and made available by participants in the exchange. The clinical data includes patient demographic data and associated medical data. Each database is a node in the clinical data exchange. The exchange enables participants to offer clinical data for research and enables researchers to engage in transactions regarding clinical data from multiple participants. The clinical data exchange includes an interface through which a researcher defines characteristics of data. A query is typically generated to help identify participant nodes that may store such data. The researcher also selects, through this interface, one or more of the participant nodes, with which the researcher would like to engage in the transaction regarding the clinical data of the selected participant. An application sends notifications to the selected participant nodes indicating that a transaction has been requested, and collects responses from the notified participant nodes indicating whether the transaction is accepted by the participant.

Transactions may be conditioned upon the performance of obligations by either the researcher, the participant or both. For example, transactions may be based on the agreement to provide a monetary payment to the participant, or the execution of a confidentiality agreement. The exchange may withhold providing clinical data to a researcher in the absence of data providing confirmation that such obligations have been met.

The multiple databases can be centrally accessed through a clinical data exchange server. The exchange server can provide the interface for researchers to define and request transactions with the participant nodes. Further, the exchange server can provide a location to aggregate data from multiple participants for analysis by the researcher. Thus, in addition to performing transactions in data with participant nodes, a researcher can analyze the data retrieved from multiple nodes.

Such an exchange server also can be used to register participant nodes for access in the clinical data exchange. An interface provided by the exchange server allows a representative of the participant to access the exchange and to register the participant node in the exchange. A node database stores information about the registered participant nodes. This information can include a computer network address and other access information for the participant node. This information can include summary information regarding the data stored in the database of the participant node. This summary information can include an indication of a research domain for the node.

To select a participant node, the exchange server can present to the researcher, through an interface, a list of characteristics of registered participant nodes. This list may be limited to participant nodes a selected research domain, or participant nodes for which the participant has already indicated a willingness to enter into a requested transaction. In the latter case, if the transaction is a query, a count of records matching the query may be provided to assist the researcher in making a selection.

In addition to registering a participant node in the exchange, and performing a queries on the databases in the exchange, and analyzing data retrieved from a query, other transactions in the exchange include, but are not limited to: recoding data in query results to provide uniformity, storing and updating information about terms and conditions under which data is being provided by a participant.

DESCRIPTION OF DRAWINGS

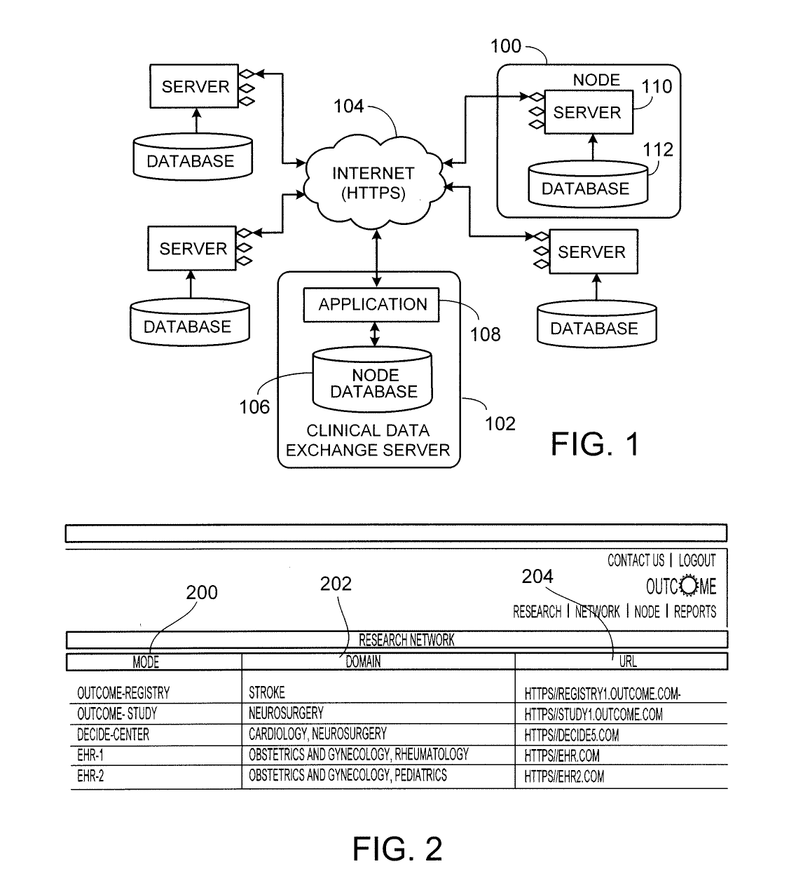

FIG. 1 is a block diagram of an example clinical data exchange.

FIG. 2 is an illustration of example contents of a node database.

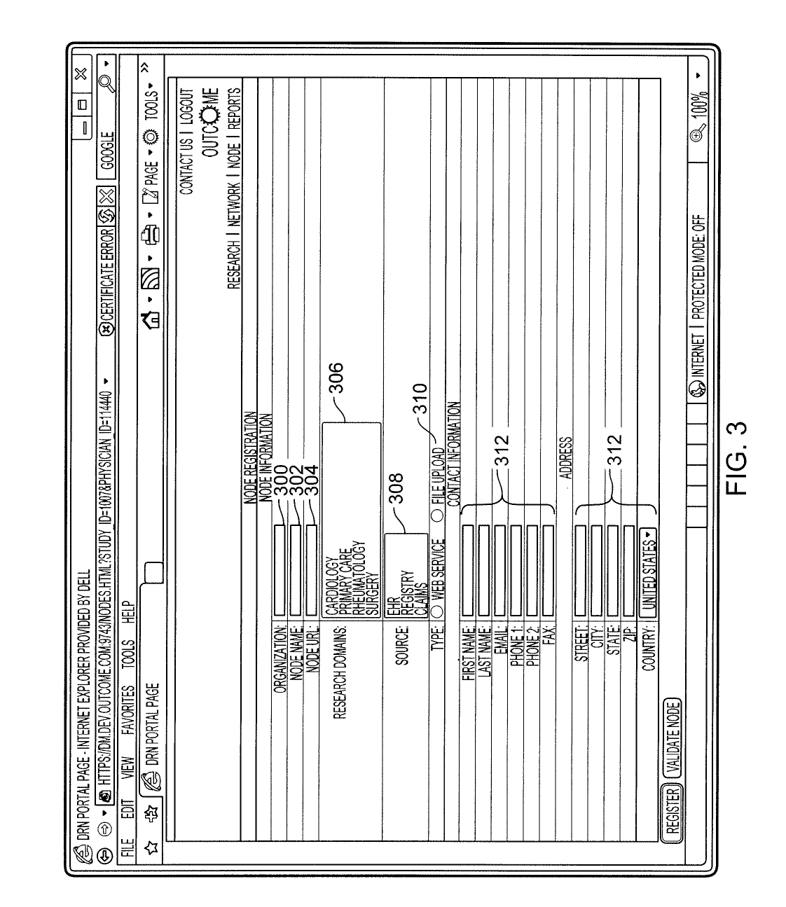

FIG. 3 is an example graphical user interface for entering information about a node.

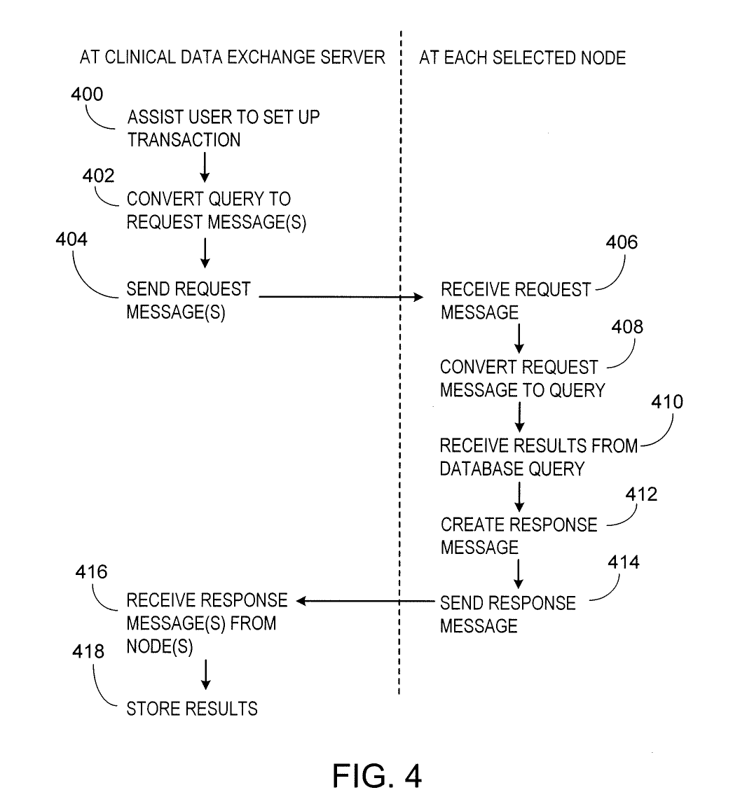

FIG. 4 is a flowchart of an example process of operation of the example clinical data exchange.

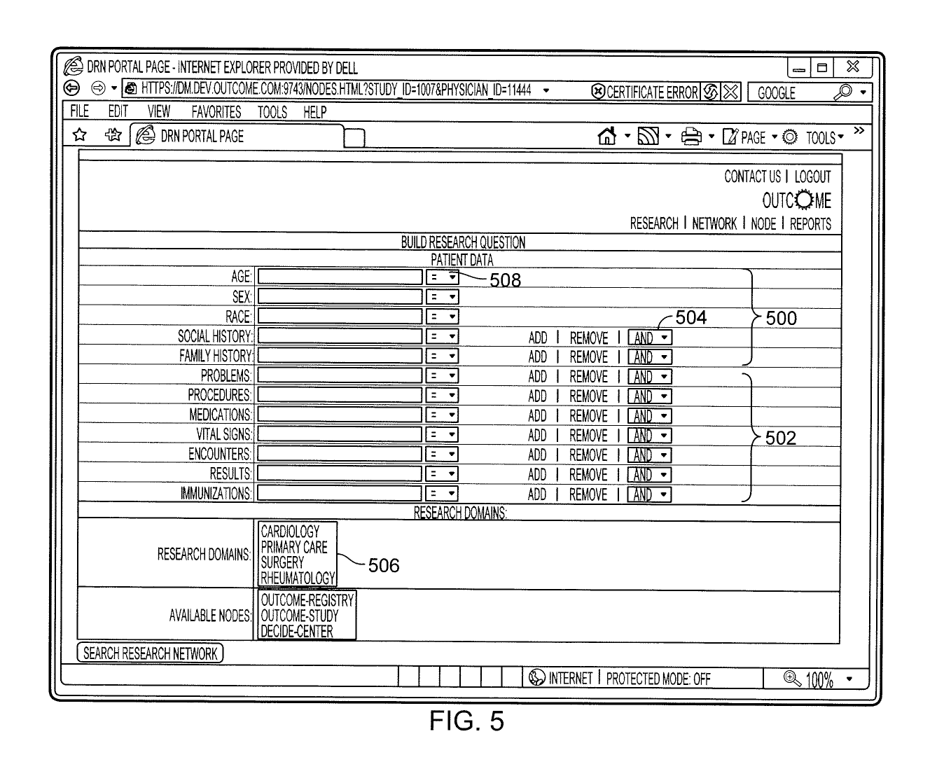

FIG. 5 is an example graphical user interface for entering a query.

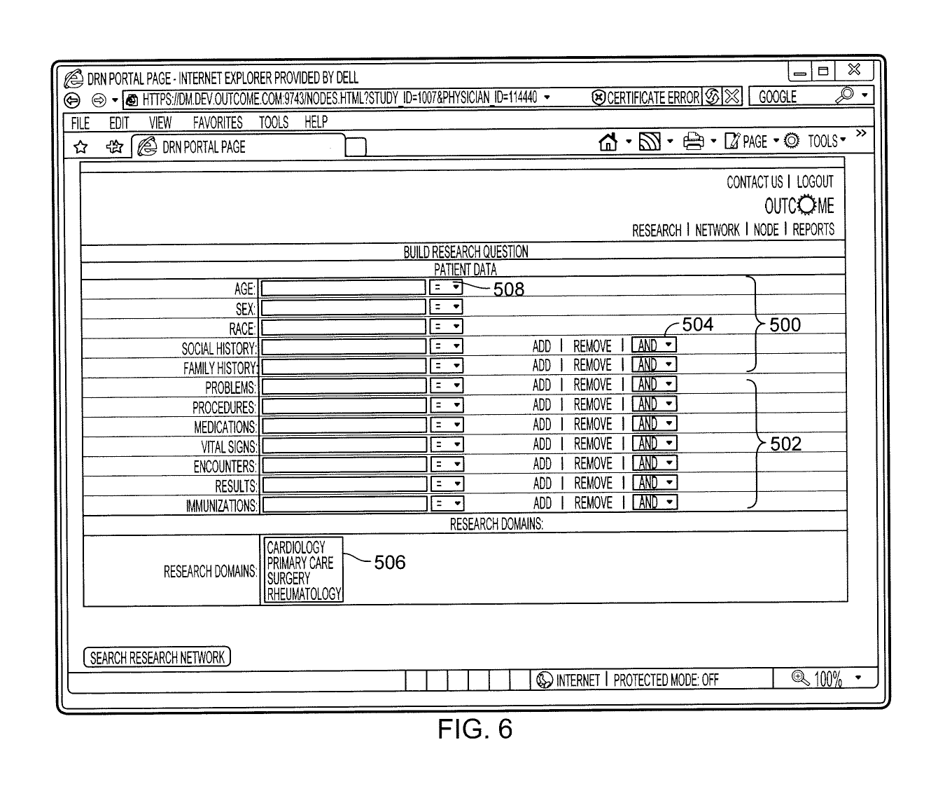

FIG. 6 is a second example graphical user interface for building a query.

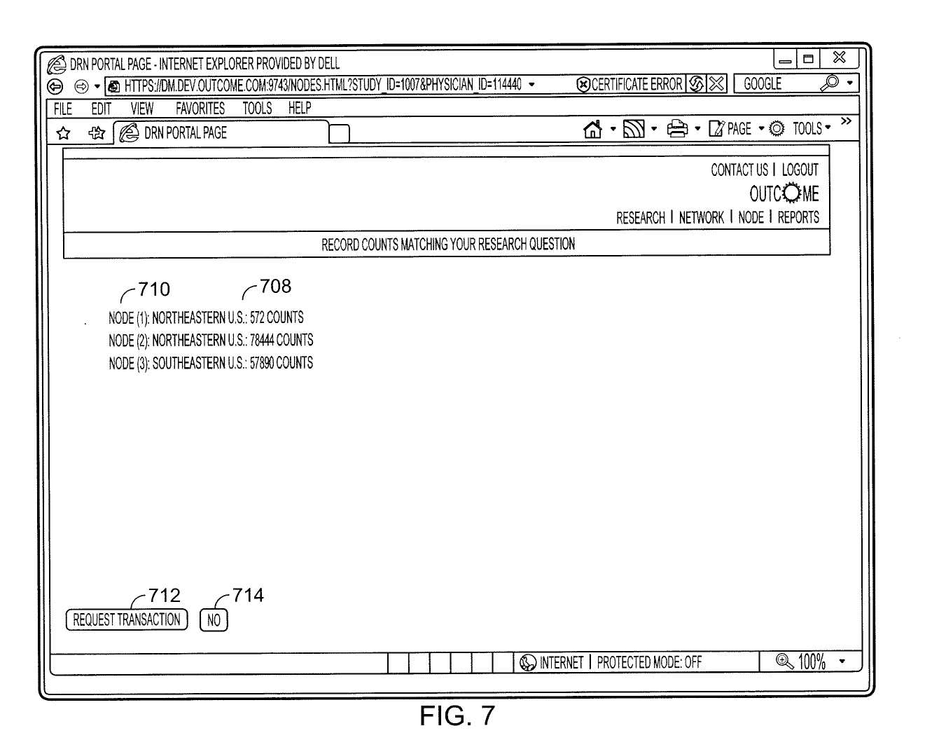

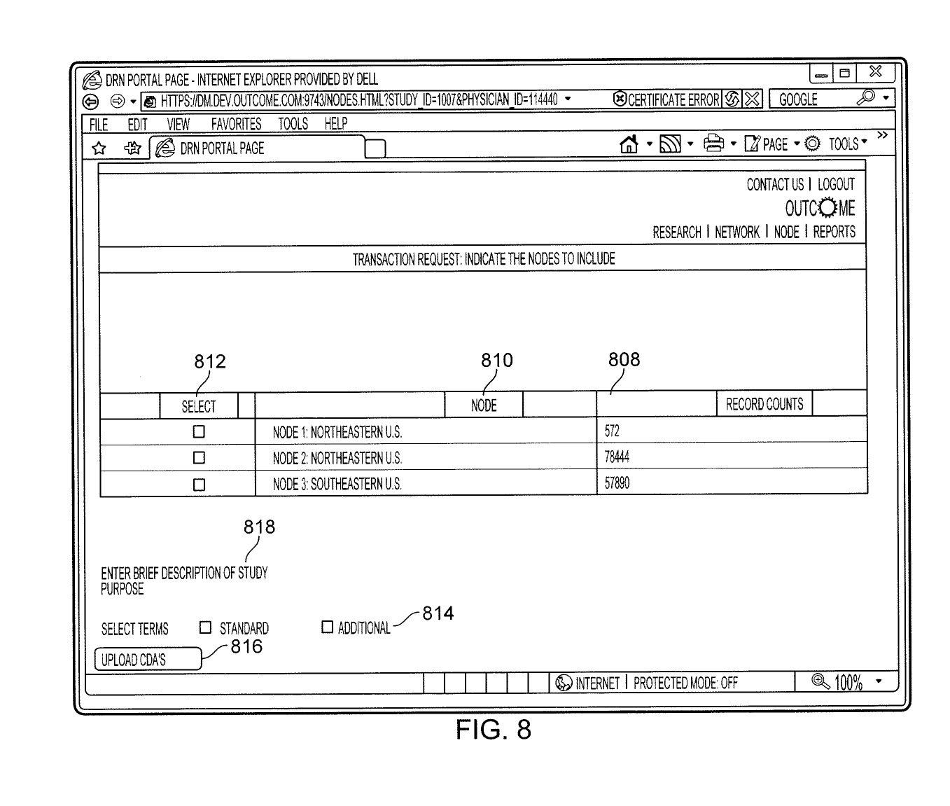

FIG. 7 is an example graphical user interface displaying counts, by node, of records matching query.

FIG. 8 is an example graphical user interface enabling a user to select nodes with which to have a transaction.

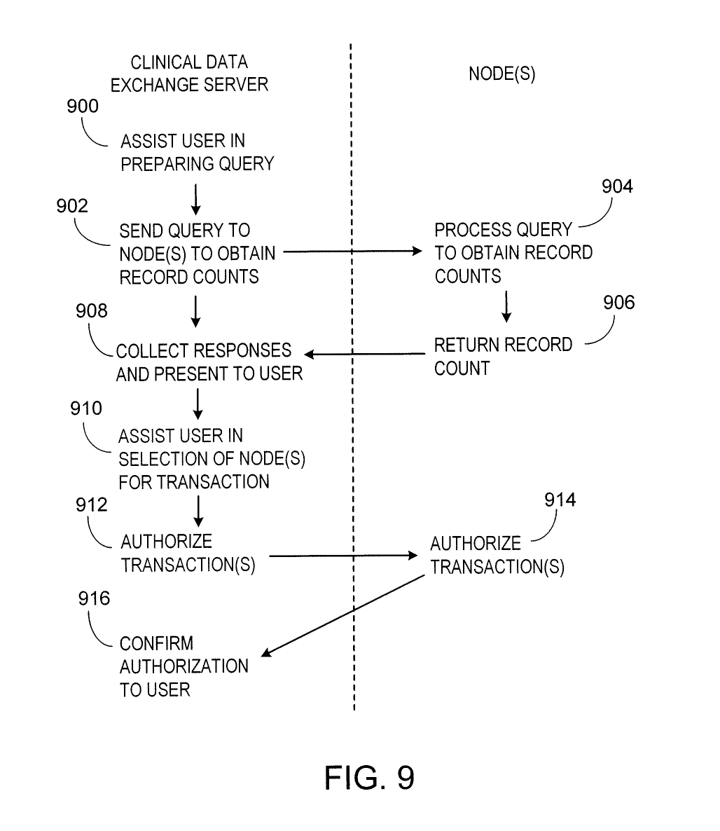

FIG. 9 is a flowchart of an example process of setting up one or more transactions through the clinical data exchange.

### DETAILED DESCRIPTION

FIG. 1 is a block diagram of an example clinical data exchange. The clinical data exchange includes multiple nodes 100. Each node is a computer that responds to clinical research transactions that can be presented, for example, through the clinical data exchange server 102. The collection of nodes, in combination with the exchange server 102, is herein called a clinical data exchange. Any number of nodes may participate in the clinical data exchange. The clinical data exchange server 102 is a computer that accesses each node over a computer network 104. The clinical data exchange server 102 performs transactions with the nodes 100, and collects the responses from multiple nodes.

The computer network 104 may be a publicly accessible computer network such as the internet. The computer network 104 also may include private computer networks. While many communication protocols may be used for sending and receiving messages over the computer network 104 between the clinical data exchange server 102 and the nodes 100, good security can be provided by using the Hypertext Transfer Protocol over Secure Socket Layer (HTTPS) protocol. In this implementation, nodes utilize an SSL Certificate that ensures their authenticity and all communications occur over 128-bit encrypted HTTPS link. If a node is accessed using HTTPS, then the node database would indicate that the https scheme is to be used to access the node.

A node is implemented as a server computer 110 that responds to request messages from the clinical data exchange server 102. The server 110 accesses a clinical data database 112. The server 110 implements a firewall; thus, the data in the database is protected behind a firewall. Authorized operators may access the data through the server, such as via secured web services over HTTPS. Each operator of the clinical data exchange server may have his/her own username and password allowing access to the research exchange.

The clinical data database 112 includes patient demographic data and medical data associated with the patient. The data about the patient includes information such as age, sex and race, and social and family history. The medical data associated with the patient includes data describing: the medical problem(s) experienced by the patient, diagnoses or condition(s) associated with the patient, procedure(s) performed on the patient, medication(s) taken by the patient, vital signs of the patient, encounter(s) with the patient by medical personnel, results or outcomes experienced by the patient, and immunizations of the patient. Various other information relevant to research on the comparative effectiveness, safety or quality of medical interventions could be stored. The data describing the results or outcomes experienced by the patient may include an indication of a score or other criteria which may indicate, determine or evaluate the effectiveness or performance of a doctor, drug or medical treatment as related to the treatment of the medical problem, whether disease, sickness or other malady, experienced by the patient.

Each node 100 is typically maintained by a different organization (herein, a “participant”) than the other nodes 100. Therefore, the actual format of the clinical data database 112 in which such data is stored will be dependent on how the participant implements the database. As described below, the participant can implement an interface through a web service, through the server 110, that would receive messages in a uniform format (described below) from the clinical data exchange server 102 requesting transaction with the clinical data database 112. The server 110 translates requests received from the exchange server 110 into a appropriate requests to the database 112. A reply message in a uniform format (described below) is constructed by the server 110, and the reply message is returned to the clinical data exchange server 102.

The clinical data exchange server 102 also is a computer that provides a variety of operations to implement clinical data exchange. A clinical data exchange manager application 108 is provided to implement these operations. Such operations include, but are not limited to, maintenance of a node database 106 by participants, and specification by researchers of transactions to be presented to the clinical data exchange. The application 108 can be implemented using an information page and a processing script. The information page is provided to a web browser that processes the information page to present a form to a user. The operator completes the form and submits it through the web browser to the clinical data exchange server 102, which processes the data using the processing script.

For example, the application 108 can be used to maintain a node database 106 which stores information about the nodes that may be accessed. An illustration of example contents of a node database 106 is shown in FIG. 2. In this example, the database includes, for each node, information describing a name 200 for the node, a description of the domain 202 of the research data stored by the node, and information 204 describing how to access the node, such as a uniform resource locator (URL), or other information from which a network address and communication protocol can be determined. The database can include other summary information about the research data stored at the node. The domain of the research data stored by the node means the clinical field or disease area in which the clinical data has been obtained. For example, the domain may be “stroke” or “obstetrics and gynecology” or “neurosurgery.” The node database, or another database at the central exchange server, can include sufficient summary information of node characteristics to enable the database to be the target of a query instead of having all queries go directly to each node.

An example form for the application 108 for inputting and/or updating node information is shown in FIG. 3. In this form, the information about a node includes a name 300 for the organization responsible for the node, i.e., the participant, a name 302 of for the node, a URL 304 for the node, and a research domain 306 for the node. The operator using this form typically would be an authorized user from the participant. To improve the accuracy and consistency of the data describing the research domains for the nodes, the research domain may be selected from a predetermined list of possible domains, which list can be updated by users of the database. This example form also allows the operator to indicate, at 308, whether the data in the node is obtained from electronic health records (EHR), a patient registry (REGISTRY) or from insurance claims (CLAIMS), or other type of record. It also allows a user to indicate, at 310, how the data in the node is updated, for example, through a file upload or a web service.

The file upload mechanism is intended to support nodes that may not have support for web service based queries. Instead, a participant may receive requests through a node, but may have some other way to produce answers to the research question. The answers could be provided, for example, through a flat file which is then uploaded into the clinical data exchange server 102 and aggregated with the other responses (web service or file upload). In another example, the answers could be provided by means of an email response to an address associated with the clinical data exchange server with or without a file attachment. Various contact information 312, such as name, electronic mail address, telephone number, facsimile number, and street address, for a participant also may be collected and stored.

Alternatively, a node may send a message to the clinical data exchange server 102 providing such information to enable the node to register itself into the node database.

After a node is registered, the “Validate Node” button as shown in FIG. 3, uses the registered information to test the node's ability to receive a test message and respond back to the clinical data exchange server 102. A successful node validation sequence allows the node to be available for participation in the exchange.

Given such a clinical data exchange, with nodes 100 and a clinical data exchange server 102, participants can offer clinical data for research and researchers can engage in transactions regarding clinical data from multiple participants. The exchange server can provide the interface for researchers to define and request transactions with the participant nodes. The researcher selects one or more of the participant nodes with which the researcher would like to engage in a transaction regarding the clinical data of the selected participant. The selected participant nodes are notified that a transaction has been requested, and responses from the notified participant nodes are collected, indicating whether the transaction is accepted by the participant. The exchange server can provide a location to aggregate data from multiple participants for analysis by the researcher. Thus, in addition to performing transactions in data with participant nodes, a researcher can analyze the data retrieved from multiple nodes.

Transactions may be conditioned upon the performance of obligations by either the researcher, the participant or both. For example, transactions may be based on the agreement to provide a monetary payment to the participant, or the execution of a confidentiality agreement, or agreement to comply with specified publication terms. The exchange may withhold providing clinical data to a researcher in the absence of data providing confirmation that such obligations have been met.

A typical transaction would be a query, or clinical research question. The process of operation of the clinical data exchange is described by the flowchart of FIG. 4. Access to the clinical data exchange prior to this operation is controlled by having a researcher login using a username and password. The researcher is authenticated as an active user and is authorized to see role-based functionality. For example, an operator in an administrator role may register new nodes in the clinical data exchange, while an operator in a researcher role may present queries or other operations to the exchange. The display of data according to user privileges is implemented according to U.S. Pat. No. 7,353,238, which is hereby incorporated by reference. Once logged in, an operator in the researcher role also may view or further analyze previously saved research data, in addition to formulating queries or other operations.

Referring now to FIG. 4, the user initiates (400) a transaction using the clinical data exchange server 102. One way to initiate a transaction is described in connection with FIG. 9 below. When the transaction is authorized for a node, the query is processed by the clinical data exchange server 102, which converts (402) it into a request message. The messages are sent (404) to each of the selected nodes 100. Each node receives (406) the request message. If the transaction has been accepted by the participant, the node converts (408) the request message into a database query for its respective clinical data database. The results of the query from the database are formatted (412) into a response message (described below). The response message is then sent (414) to the clinical data exchange server 102. The clinical data exchange server receives (416) each response message from the various nodes and stores the results. The results to each clinical research questions may be stored (418) in a persistent data store, such as the node database. These results may be indexed across key variables so that data can be easily searched, retrieved, and further analyzed following the initial clinical research question. Data from other sources can by uploaded and aggregated with the results from other same queries already received from the clinical research network and further analyzed in the same way.

The application 108 of the clinical data exchange server 102 can enable the user to formulate the query and submit the query to one or more selected nodes 100 in the clinical data exchange. For example, such functionality can be implemented using an information page and a processing script. The information page is provide to a web browser that processes the information page to present a form to the user. The user completes the form and submits it through the web browser to the clinical data exchange server, which processes the data from the form using the processing script, and formulates request messages to be sent to each selected node.

An example form for inputting a query and selecting nodes is shown in FIG. 5. In this example form, the operator may enter data describing the query to be performed, for each relevant field of data stored in the clinical data databases in the various nodes in the clinical data exchange. In particular, in this example, the operator may enter one or more values for each field of patient data 500, and each field of medical data 502. In this example, the patient data includes information such as age, sex and race, and social and family history. The medical data associated with the patient includes data describing: the medical problem(s) experienced by the patient, diagnoses or conditions(s) associated with the patient, procedure(s) performed on the patient, medication(s) taken by the patient, vital signs of the patient, encounter(s) with the patient by medical personnel, results or outcomes experienced by the patient, and immunizations of the patient. The query operator 508 also may be selected, which may indicate an equality, inequality or range operator, such as “=”, “<”, “<=”, “>=”, “<”, or “< >”. For some fields, multiple values and query operators can be selected, such as “AND”, “OR’ relationships, indicated at 504. In addition, the query may be limited by research domain, as indicated at 506, or by available node, as indicated at 508. As an example, an operator might want to search for all patients that have received a specific procedure, diagnosis, have had an adverse event, and/or are taking a specific medication.

After submission of such a form or other input describing the desired query, a request message is formulated by the clinical data exchange server 102. The request message can be in a uniform format for all nodes 100 in the clinical data exchange. An example format for the request message is shown in Appendices A and B, which are an example request message in an Extensible Markup Language (XML) format, and an XML Schema Definition (XSD) documents describing the format of a request message. The XML Schema is an XML-based alternative to a document type definition (DTD) used in the standard generalized markup language (SGML) and describes the structure of an XML document.

The results of the query from each node 100 are formatted by each node into a response message. The response messages from all nodes 100 in the clinical data exchange can be in a uniform format for all nodes (or may be in different formats). An example format for the response messages is shown in Appendices C and D, which are an example response message in an XML format and an XSD document describing the format of a response message.

The web services can support several modes of request/response operation. For example, in one mode, a node may reply simply with a number reflecting how many patients were found that match the criteria of the research question. In another mode, for example, the clinical data exchange server 102 can respond in a way in which it lists all nodes that can positively answer the research question. In another mode, for example, if a node chooses to support this mode, the node will reply with some patient information matching the criteria of the research question.

In another mode, a centralized database stores summary or actual data from nodes and the query result is generated from this centralized database without going to the node. The operator then can identify the relevant nodes and send a request for a transaction to the node based on the results received from the centralized database.

The request/response architecture of this clinical data exchange can be implemented using web services, in which each node and the clinical data exchange server are implemented as web services. These web services in turn communicate using the XML documents, described above, through the simple object application protocol (SOAP). The document in Appendix E is a web services description language for request/response XML/XSD, in XML format. The specific payload of the message request and message response represents the ontology of the message. This is a data model that represents the hierarchical structure and relationships between the data elements. The ontology language utilized to define these data models can be based on clinical research standards such as HL7, CCR, and CDISC where appropriate.

In another embodiment, a query is initially a request for a transaction with a participant node, in response to which the participant node can provide, if the transaction is accepted, a count of the number of records that would be responsive to the query. After receiving counts from one or more nodes, the researcher can then generate an additional request for an additional transaction. This additional request would inquire as to the willingness of the participant to participate in a data transaction or transfer of data or research study under a defined set of terms. Data could be transferred to the clinical data exchange server, for use either individually or aggregated with other data sets from other nodes. The transaction itself may be processed by the system with a node level operator authorizing the participation of their node in such transactions after reviewing the terms of such transactions. Such terms could include payment or execution of a confidentiality agreement, for example.

In this embodiment, the interface of FIG. 5 would be modified so as to eliminate the selection of nodes from building the query as shown in FIG. 6. Instead, the exchange server would determine a number of counts for each node. Then, the interface would display a screen such as shown in FIG. 7. In this screen, the number of counts 708 is displayed per node 710. The user would have the option to continue with the transaction or not, such as by using selectors 712 and 714. If the user selects to continue with the transaction, the screen of FIG. 8 is displayed. In this screen, the number of counts 808 is displayed per node 810. A selector 812, per node, is provide to allow a researcher to indicate whether the researcher would like a transaction with that node. The researcher could enter text in box 818 describing the purpose of the study that is going to use the requested data. The terms of the transaction also can be selected (814). A button 816 could be provided to continue with uploading appropriate agreements or other documents expressing the terms and conditions of the data transfer from each node.

A flowchart of an example process of setting up one or more transactions through the clinical data exchange will now be described in connection with FIG. 9. The clinical data exchange server assists (900) the user in preparing a query. An example user interface for entering a query is shown in FIG. 5 and described above. Both the query and the nodes can be selected by the operator. Nodes may be selected directly by name, or indirectly by research domain or through other information. The query is sent (902) to the nodes to obtain information about how responsive the node can be to the query, for example, by identifying the number of records the node contains that match the query. A node receives and processes (904) the query to obtain a record count, and returns (906) the record count to the server 102. The server 102 collects (908) these responses and presents them to the user, such as shown in FIG. 7 above. The server 102 assists (910) the user in selection of nodes for the transaction, such as through the interface of FIG. 8. The server 102 authorizes (912) the transaction with each selected node. Each selected node responds to the server 102 to authorize (914) the transaction. This authorization is confirmed to the user by the server (916) and the transaction can proceed (for example, according to the process in FIG. 4).

While the operations of registering a participant in the exchange and performing a query on the databases in the exchange are described above, yet other operations can be performed on this clinical data exchange. For example, analyses of data retrieved from a query can be performed by the clinical data exchange server. As another example, data in participant databases can be recoded. Information about terms and conditions under which data is being provided by a participant also may be stored and updated.

The techniques described above can be implemented in digital electronic circuitry, or in computer hardware, firmware, software processed by a general purpose computer, or in combinations of them. The techniques can be implemented as a computer program product, i.e., a computer program tangibly embodied in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computing system can include clients and servers. A client and server are generally remote from each other and typically interact over a communication network. The relationship of client and server arises by virtue of computer programs running on the respective computers and having a client-server relationship to each other.

Having described an example embodiment, it should be apparent to those skilled in the art that the foregoing is merely illustrative and not limiting, having been presented by way of example only. Numerous modifications and other embodiments are with the scope of ordinary skill in the art and are contemplated as falling with the scope of the invention.

What is claimed is:

1. A computer system for supporting database transactions on multiple networked databases of clinical research data, comprising:
a. a plurality of participant nodes, wherein each participant node comprises a server computer for accessing a database made available by a different participant, wherein a participant is an entity that maintains a database of clinical data, and wherein the database, made available through each participant node by a participant, stores, in computer readable storage, the clinical data from that participant, the clinical data including patient demographic data and associated patient medical data for a plurality of patients;
b. an exchange server connected to the plurality of participant nodes by a computer network, wherein the exchange server comprises a computer having persistent storage and executing computer programs that implement:
i. a node database configured to store in the persistent storage, for each participant node, data describing how to access the participant node and summary information describing data available from the participant node;
ii. an interface configured to:
a. receive data from a user defining a database transaction, the database transaction comprising a database query specifying clinical data for a plurality of patients to be retrieved from databases of selected participant nodes, and
a. present information on a display from the node database indicating at least the summary information for participant nodes;
b. receive data from the user defining a selection from among the participant nodes; and
iii. an application that:
a. sends a request message from the exchange server to each of the selected participant nodes over the computer network based on at least the data describing how to access the participant node from the node database, the request message indicating that the defined database transaction has been requested by the user for the participant to provide clinical data for a plurality of patients from the participant's database to the exchange server for use by the user, the provided clinical data being responsive to the database query of the defined database transaction, and
b. collects responses from the each of the participants that maintain the databases of the selected participant nodes indicating whether the defined database transaction is accepted by that participant, and
c. applies the database query to clinical data stored in the persistent storage of the exchange server, and provides data responsive to the database query from the persistent storage to the user;
d. submits request messages, in a uniform format across the selected participant nodes, including data defining the database query of the defined database transaction to the selected participant nodes over the computer network based on the data describing how to access the participant node from the node database, after the participant corresponding to the selected participant node accepts the defined database transaction,
wherein the server computer of each of the selected participant nodes is configured to convert the request message in the uniform format and to apply the converted database query to the database of the participant to retrieve the clinical data for a plurality of patients from the database, and to transmit the retrieved data to the exchange server over the computer network using response messages of a uniform format across the selected participant nodes, and
e. receives and aggregates clinical data for a plurality of patients from each database of the databases of the selected participant nodes, at least a portion of the clinical data being stored in the persistent storage of the exchange server accessible for database queries by the interface, responsive to the submitted database query of the defined database transaction, for use by the researcher in performing analysis on the aggregated clinical data.

2-6. (canceled)

7. The computer system of claim 1, wherein the data describing how to access the participant node includes at least a computer network address and access information for the participant node.

8. The computer system of claim 1, wherein the summary information for each participant node includes summary information regarding the data stored in the database of the participant node.

9. The computer system of claim 8, wherein the summary information includes an indication of a research domain for the node, and wherein each node stores clinical data including patient demographic data and associated medical data in the research domain for the node.

10. The computer system of claim 1, wherein the database transaction includes an indication of a research domain and the selected number of the nodes includes the nodes in the selected research domain.

11. The computer system of claim 1, wherein the response from a participant node indicating whether the database transaction has been accepted further comprises a set of clinical data from the database of the participant node.

12. The computer system of claim 1, wherein the defined database transaction has a defined set of terms.

13. The computer system of claim 1, wherein the interface further permits the operator to perform a database query on data in the persistent storage to identify participant nodes having data of interest to the operator.

14. The computer system of claim 13, wherein results of the database query include characteristics of the participant nodes that store the data of interest to the operator.

15. The computer system e of claim 14, wherein the characteristics of the participant nodes is a list of the participant nodes and information regarding the characteristics of the data stored by the participant node.

16. The computer system of claim 14, wherein the characteristics of the participant nodes comprises the geographic area of the data stored by the participant node.

17. The computer system of claim 14, wherein the characteristics of the participant nodes comprises a number of cases for which data is stored by the participant node.

18. A process for operating a computer system for supporting database transactions on multiple networked databases of clinical research data, the clinical data exchange comprising a plurality of participant nodes and an exchange server connected to the plurality of participant nodes by a computer network, wherein each participant node comprises a server computer for accessing a database made available by a different participant, wherein a participant is an entity that maintains a database of clinical data, and wherein the database made available through each participant node by a participant stores, in computer readable storage, the clinical data from that participant, the clinical data including patient demographic data and associated patient medical data for a plurality of patients, and wherein the exchange server comprises a computer having persistent storage and a node database configured to store in the persistent storage, for each participant node, data describing how to access the participant node and summary information describing data available from the participant node, the exchange server further executing computer programs that implement the process, comprising:
receiving data from a user defining a database transaction comprising a database query specifying clinical data for a plurality of patients to be retrieved from databases of selected participant nodes;
presenting information on a display from the node database indicating at least the summary information for participant nodes;
receiving data from the user indicating a selection from among the participant nodes;
sending a request message from the exchange server to the selected participant nodes over the computer network based on at least the data describing how to access the participant node from the node database, the request message indicating that the defined database transaction has been requested by the user for the participant to provide clinical data for a plurality of patients from the participant's database to the exchange server for use by the user, the provided clinical data being responsive to the database query of the defined database transaction;
collecting responses from each of the participants that maintain the databases of the selected one or more of the participant nodes indicating whether the defined database transaction is accepted by that participant;
applying the database query to clinical data stored in the persistent storage of the exchange server and providing data responsive to the database query from the persistent storage to the user;
submitting request messages in a uniform format across the selected participant nodes, including the database query of the defined transaction to the selected participant nodes over the computer network, based on at least the data describing how to access the participant node from the node database, after the participant, corresponding to the selected participant node, accepts the defined transaction;
the server computer of the each of the selected participant nodes converting the request message in the uniform format to a database query for the database of the participant node, and applying the database query to the database of the participant node to retrieve the clinical data for a plurality of patients from the database, and transmitting the retrieved data to the exchange server over the computer network using response messages of a uniform format across the selected participant nodes; and
receiving and aggregating clinical data for a plurality of patients from each database of the databases of the selected one or more of the participant nodes responsive to the submitted database query of the defined transaction, at least a portion of the clinical data being stored in the persistent storage of the exchange server accessible for database queries by the interface, for use by the user in performing analysis on the aggregated clinical data.

19. (canceled)

20. The process of claim 18, wherein the data describing how to access the participant node includes at least a computer network address and access information for the participant node.

21. The process of claim 18, wherein the summary information for each participant node includes summary information regarding the data stored in the database of the participant node.

22. The process of claim 21, wherein the summary information includes an indication of a research domain for the node, and wherein each node stores clinical data including patient demographic data and associated medical data in the research domain for the node.

23. A process for operating a computer system for supporting database transactions with a plurality of database nodes, the computer system comprising a plurality of database nodes and an exchange server connected to the plurality of database nodes by a computer network, wherein each database node comprises a server computer that accesses a database, each database node housing a different database from other database nodes, and wherein the database made available through each database node stores, in computer readable storage, clinical data including patient demographic data and associated patient medical data for a plurality of patients, and wherein the exchange server comprises a computer having persistent storage and a node database configured to store in the persistent storage, for each database node, data describing how to access the database node and summary information describing data available from the database node, the exchange server further executing computer programs that implement the process, comprising:
the exchange server receiving data defining a database transaction comprising a database query specifying clinical data for a plurality of patients to be retrieved from each database of a set of databases of selected database nodes;
the exchange server presenting a user interface on a display including information from the node database indicating at least the summary information for database nodes and enabling a user to provide a selection of a plurality of the database nodes;
the exchange server receiving data indicating the selection of a plurality of the database nodes;
the exchange server sending a request message over the computer network to each of the selected database nodes based on at least the data describing how to access the database nodes from the node database, the request message indicating the defined database transaction has been requested for the database node to provide clinical data for a plurality of patients from the database of the database node to the exchange server for use by the user, the provided clinical data being responsive to the database query of the defined database transaction;
the exchange server collecting responses for each of the selected database nodes indicating whether the defined database transaction is accepted;
the exchange server applying the database query to clinical data stored in the persistent storage of the exchange server and providing data responsive to the database query from the persistent storage to the user;
the exchange server submitting request messages in a uniform format across the database nodes, including the database query of the defined database transaction, to the selected database nodes over the computer network, based on at least the data describing how to access the participant node from the node database, after acceptance of the defined database transaction for the selected database node;
the server computer of each of the selected participant nodes converting the request message in the uniform format to a database query for the database of the database node, and applying the database query to the database of the database node to retrieve the clinical data for a plurality of patients from the database, and transmitting the retrieved data to the exchange server over the computer network using response messages of a uniform format across the selected database nodes;
the exchange server receiving clinical data for a plurality of patients from each of the selected database nodes to which the database query of the defined database transaction is submitted;
the exchange server aggregating the received clinical data in the persistent storage for access by the user, and at least a portion of the clinical data being stored in the persistent storage of the exchange server accessible for database queries through the user interface; and
the exchange server enabling the user to direct the exchange server to perform analysis on the aggregated clinical data in the persistent storage for the user.

24. The process of claim 18, wherein applying the database query to data in the persistent storage is performed prior to receiving the selection of the database nodes, and wherein presenting information about the participant nodes includes presenting results from the database query for data stored in the persistent storage from the participant nodes.

25. The process of claim 24, wherein presenting the results comprises presenting a number of cases matching the database query from the data is stored for the participant nodes.

26. The process of claim 23, wherein applying the database query to data in the persistent storage is performed prior to receiving the selection of the database nodes, and wherein presenting information about the participant nodes includes presenting results from the database query for data stored in the persistent storage from the participant nodes.

27. The process of claim 26, wherein presenting the results comprises presenting a number of cases matching the database query from the data is stored for the participant nodes.
